(19) United States
(12) Patent Application Publication
(10) Pub. No.: US 2007/0088627 A1
(43) Pub. Date: Apr. 19, 2007

(54) Brochure creation internet system

(76) Inventors: Peter Elson, Newport Coast, CA (US); Tim Hon, Berkeley, CA (US); Henry Hon, Berkeley, CA (US); Rick Skalak, Valencia, CA (US); Rodger Gariano, Woodland Hills, CA (US)

Correspondence Address: PATENT LAW & VENTURE GROUP, 2424 S.E. BRISTOL, SUITE 300, NEWPORT BEACH, CA, 92660, US

(21) Appl. No.: 11/250,836

(22) Filed: Oct. 14, 2005

(51) Int. Cl. G07F 7/00

(52) U.S. Cl. 705/27

(57) ABSTRACT

An Internet business site provides a service to users for creating brochures and other information pieces using data elements found in Internet sites that have been activated for making copies of the data elements upon selection by users.

### BACKGROUND

1. Field of the Present Disclosure

This disclosure relates generally to computer systems and methods and more particularly a method of creating brochures from Internet web sites.

2. Description of Related Art

Eichel et al., U.S. 2002/0030689, discloses a storyboard of interior design surface treatments for a commercial and/or residential interior space that is generated by obtaining a plurality of arrays of patterns that correspond to user search criteria, from a stored set of patterns for interior design surface treatments. The arrays of patterns are displayed on a computer display. Each array of patterns corresponds to a surface treatment product type, such as floor treatments, upholstery, textiles (fabrics), wall treatments and solid surface materials or laminates (countertops). The product type also can include product subtypes, such as carpet, vinyl composition tile, resilient sheet flooring, porcelain tile and ceramic tile for floor treatments. A plurality of subarrays of patterns then are generated, each subarray corresponding to a surface treatment product type. The plurality of subarrays of patterns are generated in response to selection by a user, generally an interior designer/decorator, architect, facility planner, product dealer and/or general contractor, from the corresponding array of patterns for the corresponding surface treatment type. Finally, at least one pattern from at least two of the subarrays of patterns are combined to produce a storyboard of interior design surface treatments for an interior space. Thus, large numbers of patterns may be considered and combined without the need to peruse a large library of sample books. Moreover, the one or more storyboards may be generated without the need to physically order samples or cut samples from sample books. The subarrays of patterns that are under consideration and/or one or more storyboards, may be viewed on a computer system, and may be emailed and/or printed and sent to a client to allow improved efficiency in the decision-making process. Data mining, standardized patterns and attributes, storyboard enhancements, additional user search criteria, discontinued product handling and locators also may be provided. Carlin, U.S. 2002/0093538, discloses how a design professional such as an interior designer, furniture sales associate or advertising designer running a browser program at a client computer (i) uses the world wide web to connect to a graphics server computer, and (ii) interactively selects or specifies furnishings or other objects from this server computer and previews the scene and communicates with the server, so as to (iii) receive and display to his or her client a high-fidelity high-quality virtual-reality perspective-view photorealistic image of furnishings or other objects displayed in, most commonly, a virtual representation of an actual room of a client's home or an advertisement scene. The photorealistic images, optionally provided to bona fide design professionals and their clients for free, but typically paid for by the product's manufacturer, promote the sale to the client of goods which are normally obtained through the graphics service provider's customer's distributor, profiting both the service provider and the design professional. Models, textures and maps of existing objects are built as necessary from object views or actual objects. Full custom objects, including furniture and other products not yet built, are readily presented in realistic virtual image. Also, a method of interactive advertising permits a prospective customer of a product, such as furniture, to view a virtual but photorealistic, image of a selected product located within a customer-selected scene, such as the prospective customer's own home, to allow in-context visualization. Weiner, U.S. 2002/0161464, discloses a method that allows a consumer to personalize a label for a product. The consumer performs the steps including inputting data into a workspace defined by software and obtaining a label comprising at least one of text and an image printed on a substrate. The software is adapted to generate personalized data comprising (a) at least one of text data and image data selected or created by a consumer and (b) location data that represent the location of at least one of text data and image data in the workspace. At least one of the text and image is printed in accordance with the personalized data. The consumer can then secure the label to the product. Glinsky, U.S. 2003/0233616, discloses a computer-implemented method and system for creating and implementing dynamic clip art images in a software module. Clip art images are typically static in nature and cannot be modified by a user. This limitation with conventional clip art images makes them inflexible and inefficient. In contrast, a dynamic clip art image can be used to represent several similar static clip art images. Those elements of the similar static images that are distinct can be represented by dynamic properties that can be customized by a user. Dynamic clip art images can be modified by a user while inserted in an electronic document thereby eliminating the need to locate new static clip art images to replace existing static images in a document. Fletcher, U.S. 2004/0205695, discloses a system for building web applications in a client-server computing environment, including a server-side software engine including a database interface for a database of three-dimensional graphics objects, and a web application configuration file including initialization settings for a server computer and design settings for a graphical user interface for a web application, and a client-side software engine including a programming interface for developer plug-ins that render the three-dimensional graphics objects, and a web application user interface manager that provides a user interface for the web application based on contents of the configuration file. A method is also described and claimed. Oberg, U.S. Pat. No. 5,870,771, discloses a computerized system having means for displaying a digital image of an object such as an object of artwork supplied by the user, analyzing the color composition of the image, searching a database for coordinating frame and matting material products, developing composite images of the user's input with the matching selections, and presenting the digital images to the user so the items may be previewed before placing an order. The system interfaces with a mobile digital camera system for taking digital pictures of input supplied by the customer. The image may be cropped or otherwise altered and combined with the selected frame moulding and matting material combinations. The user may experiment with various features such as color, shape, size, width, number of openings, and other characteristics of frames and matting material until the desired combination is achieved. The system also includes a database of merchandising information such as products and materials, colors and designs available, model numbers, size, material type, cost, and supplier source. The system is capable of generating a printout of the composite image and associated data, and of storing the data for later use. Thomas et al., U.S. Pat. No. 6,005,969, discloses a methods and system that enable a highly streamlined and efficient fabric or textile sampling and design process particularly valuable in the design and selection of floor coverings, wall coverings and other interior design treatments. A digital library of fabric models is created, preferably including digitized full-color images and having associated a digital representation of positions that are located within and which characterize the models. Via an application implemented according to conventional software methods and running on conventional hardware having high resolution graphics processing capabilities, a user may navigate among the set of alternative models, and may modify the positions of the selected models to test out desired combinations of characteristics—such as poms or yam ends, for models of floor coverings—and view the results in high resolution. In particular, and also according to the present invention, a method is provided for substituting colors in digital images of photographic quality, while preserving their realism particularly in the vicinity of shadows. The resulting samples or designs can be stored and transmitted over a telecommunications network or by other means to a central facility that can either generate photographic-quality images of the samples, or can directly generate actual samples of the carpet or other material of interest. Eichel et al., U.S. Pat. No. 6,664,972, discloses a storyboard of interior design surface treatments for a commercial and/or residential interior space that is generated by obtaining a plurality of arrays of patterns that correspond to user search criteria, from a stored set of patterns for interior design surface treatments. The arrays of patterns are displayed on a computer display. Each array of patterns corresponds to a surface treatment product type, such as floor treatments, upholstery, textiles (fabrics), wall treatments and solid surface materials or laminates (countertops). The product type also can include product subtypes, such as carpet, vinyl composition tile, resilient sheet flooring, porcelain tile and ceramic tile for floor treatments. A plurality of subarrays of patterns then are generated, each subarray corresponding to a surface treatment product type. The plurality of subarrays of patterns are generated in response to selection by a user, generally an interior designer/decorator, architect, facility planner, product dealer and/or general contractor, from the corresponding array of patterns for the corresponding surface treatment type. Finally, at least one pattern from at least two of the subarrays of patterns are combined to produce a storyboard of interior design surface treatments for an interior space. Thus, large numbers of patterns may be considered and combined without the need to peruse a large library of sample books. Moreover, the one or more storyboards may be generated without the need to physically order samples or cut samples from sample books. The subarrays of patterns that are under consideration and/or one or more storyboards, may be viewed on a computer system, and may be emailed and/or printed and sent to a client to allow improved efficiency in the decision-making process. Data mining, standardized patterns and attributes, storyboard enhancements, additional user search criteria, discontinued product handling and locators also may be provided. Edwards, WO 03/087976, discloses a system and method for designing custom designed and printed media. The system enables a user to access the system and design , for example, a custom wall covering. The system may present the user with a variety of product options from which the user may select. Based on the product options selected, the user may be presented with various custom criteria. The custom criteria may enable the user to customize various characteristics of the wall covering such as size, color, pattern or other. The user may select one or more of the custom criteria. Additionally, the user may be provided with an option to insert text or images not provided in the custom criteria. The images may be stored at a user's or other location. A digital sample image may be generated based on the product options and custom criteria input by the user. The sample image may be presented to the user on a display device. The user may modify the sample image, request that the sample image be printed or downloaded or other function. If the user desires to obtain a wall covering that includes the customization, the user may order a predetermined amount of the wall covering. The system may request payment information from the user for an order that the user desires to place. After receiving the payment information, the system may process and print the order. The order may also be delivered to the user. Oy, EP 1416404, discloses a system that relates to a novel method of open building and means for implementing this method. According to the invention, a support for a structural unit to be designed and interior equipment contained therein, are designed separately from each other. The room spaces are selected from a number of ready to use room space solutions which are placed on a layout of the support. If necessary, the measurement data of the room space solutions is changed for adapting the same to the support of a building.

The present method distinguishes over the prior art in providing a method that includes the steps of enabling a plurality of web sites with enable icons positioned at selected locations within each; enabling a plurality of users to have access to these web sites and to view the enable icons; enabling the storing of selected items on the web sites by selecting associated enable icons; and placing the selected items into a brochure template to complete a commercial brochure.

### SUMMARY

This disclosure teaches certain benefits in construction and use which give rise to the objectives described below.

An Internet business site provides a service to users for creating brochures and other information pieces using data elements found in Internet sites that have been activated for making copies of the data elements upon selection by users.

A primary objective inherent in the above described apparatus and method of use is to provide advantages not taught by the prior art.

Another objective is to enable users to enter web sites and select element from these sites for use in creating a brochure.

A further objective is to provide a service that received revenue from existing web sites that wish to enable data elements thereon to be copied for commercial use by users.

Other features and advantages of the described apparatus and method of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawing illustrates a best mode embodiment of the present apparatus and method of use. In such drawings:

FIGS. 1a-c are a logic flow diagram, in three parts, showing the preferred steps in the present method for creating a brochure, chart, presentation, storybook and the like.

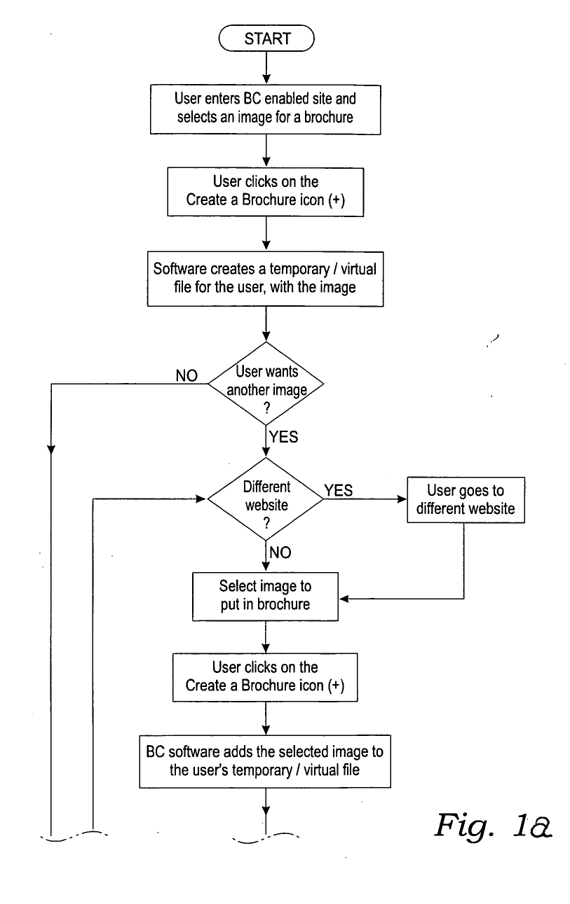

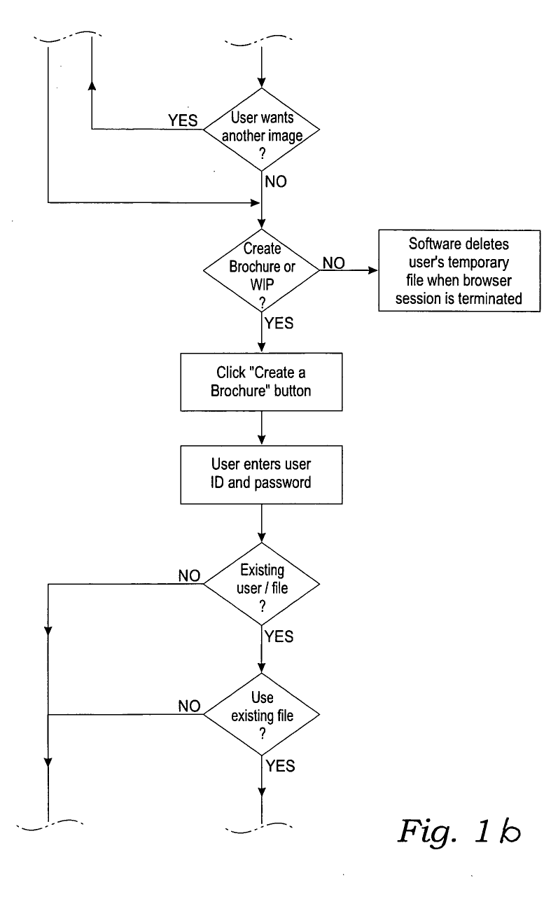

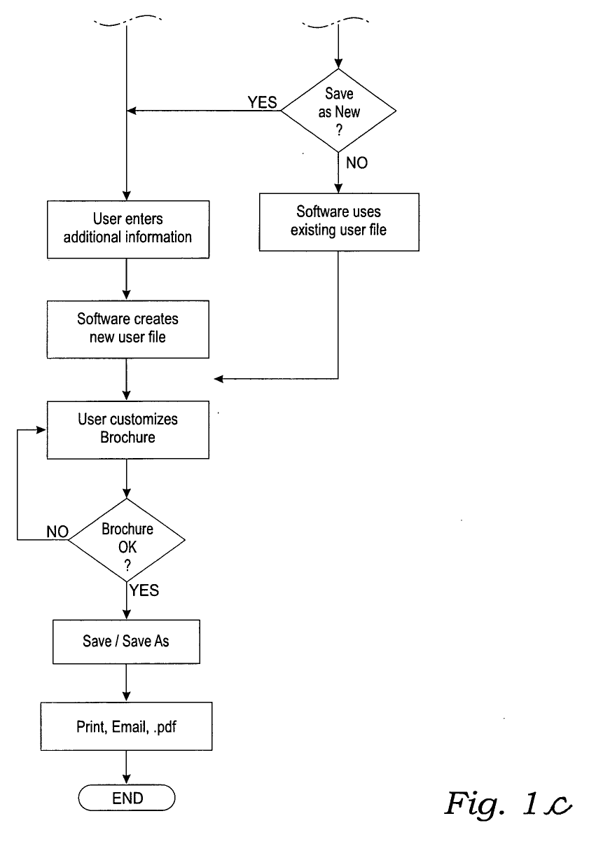

### DETAILED DESCRIPTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

The presently described process creates an article of information. The information article may be a brochure, a pamphlet, a booklet, a sales piece or any one of many other possible embodiments. We shall refer to the article created using the present method as a brochure, but the word “brochure” shall refer herein to any publication whatsoever, that is created using the present method, whether in print or a digital form such as residing on a web site of the Internet or other information exchange medium. Such a brochure may be sent to an intended person, organization or association or to clients, associates, partners, family members, etc., and may be presented to them as handbills, through the U.S. mail, facsimile, email, data transfer, or simply by a visual form such as a power point presentation. Any other method of communicating the information found in the brochure may be just as suitable. The brochure may be used to inform, sell, surprise, enlighten, educate, or fullfil many other objectives.

The brochure is assembled from material found on the Internet, referred to herein as “data elements.” Such data elements may be static including text, charts, images, graphics, photographs, animations, videos, music and realistically any digital entity that may be found on a web site or which is imbedded within a web site or even attached thereto. Further, dynamic elements such as 3D spin-arounds may also be included.

In the present method each of a plurality of Internet web sites is enabled for allowing a grab function of selected data elements resident on the sites. Such a grab function may be similar to any of the item selection techniques defined in the above prior art disclosures and is, in itself, well known in the art. The process of assembling a brochure requires the user to select a web site that is grab function enabled. When the user finds a data element on such a site that the user wants to place within a brochure he or she is creating, the user moves his display screen pointing device, over a grab icon (enable icon) which has been placed adjacent to, or in the proximity of, the data element and clicks on it or otherwise selects it. This results in a copy of the element being made and placed into a work file as working material. The grab icon may be any pictorial element selected and identified as an indicator that its associated data element is available for grabbing.

This grab function is repeated as often as necessary or desired by the user until all of a set of working material has been assembled in his work file. We speak herein of a user, but such usage also hereby has the meaning of a plurality of users wherein each said user is most likely acting alone to accomplish the production of a brochure that is unique to his own needs. A key step in making the web sites available to this grab function is placing the enable icon adjacent to each selectable data element that is to be made available to the users visiting the web sites.

In assembling or creating a brochure, the user moves from web site to web site selecting each grab enable icon related to a data element that appears of interest. This process may be described as: entering a web site selected from a plurality of web sites; selecting a grab icon of a data element of the entered web site; storing the data element in a work file; repeating these steps for each data element of interest; moving to the next web site and repeating the same steps. When the user is satisfied that copies of all of the useful data elements have been placed within his work file, he selects a brochure template which may be a stored existing template partially completed, or a new template. Some or all of the data elements in the work file are then transferred to the brochure template.

In the present method, a commercial web site (business site) is made available to users so as to provide the service of enablement of the brochure creating function described above. A user wishing to create a brochure enters the web site and registers in a traditional manner common to most Internet enterprises. The web site may require a fee from the registered user or the web site's revenue model may be to obtain fees from grab enabled sites that operate in cooperation with the business site. In either case, the registered user is then able to obtain a pass code that enables the user to open a temporary work file on the business site. With the work file, the user is able to move from Internet web site to web site selecting those items that are grab enabled and of interest to the user. The selections, as defined above, are placed in the work file and when the selection process is complete, the work file contains copies of data elements from the several visited web sites. Along with each data element stored in the work file is information about the data element including which web site it was obtained from and a time and date stamp.

Next, moving back to the business site, the user may select from a large number of brochure templates, including those that create a brochure, a booklet, a pamphlet, a flyer, an ad, a bulletin, a newsletter, a product sheet, and a catalog, to mention only some of the possibilities. The user now is ready to populate his template with data elements found in his work file. The user may select more than one template, as for instance, some of the same data elements may be used for a flyer which is used as a marketing tool, and also a catalog which is used as a sales tool. Working within the populated template the user can rearrange and resize grabbed elements, add additional text, logos, backgrounds, and other such modifications as the user may require in order to achieve the desired final result. When completed with the task at hand, the user may save the finished brochure and, or the work file, on the business site for future reference, or may merely save the brochure and discard the work file.

The enablement of an existing web site for execution of the grab function requires the placement of the grab icon next to each data element that is on the site. Such a grab element is preferably an icon as for instance an open hand posed for gripping something as is often used for moving through PDF documents on a monitor screen and which is well known in the prior art. When this icon is selected it triggers program code that makes a copy of the related data element and places the copy into the users work file. Preferably, the enablement of a client web site is accomplished by the owners of the web site. Thus, the business site provides a program that a web site personnel may use to place the grab icon and activate it.

The enablements described in detail above are considered novel over the prior art of record and. are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A method for creating information pieces by a plurality of independent users, wherein each of the users is interconnected for data exchange through the medium of the Internet to view Internet web sites of each user's choice on a computer display, the method comprising the steps of:
a) enabling a plurality of the web sites for grab use by the users including placing an enable icon adjacent to at least one data displayed on each one of the enabled web sites;
b) selecting a brochure creation icon, thereby establishing a user work file;
c) entering one of the enabled web sites;
d) selecting an enable icon of the entered web site;
e) storing a data associated with the enable icon in the work file;
f) repeating steps (d) through (e) n times for n≧0;
g) repeating steps (c) through (f) m times for m≧0;
h) saving the work file;
i) selecting a new brochure template; and
j) populating the template with at least one of the data stored in the work file.

2. The method of claim 1 further comprising the steps of placing grab icons on an existing Internet site, the grab icons positioned relative to each of a plurality of data elements of the internet site and activating the grab icons so that when one of the grab icons is selected, a copy of the data element is made and the copy is placed in a working file.
